(19) United States
(12) Patent Application Publication
(10) Pub. No.: US 2003/0208388 A1
(43) Pub. Date: Nov. 6, 2003

(54) Collaborative bench mark based determination of best practices

(76) Inventors: Bernard Farkas, Vienna, VA (US); Donald H. Seifman, McLean, VA (US); Jonathan Chiat, Reston, VA (US)

Correspondence Address: JACOBSON HOLMAN PLLC, 400 SEVENTH STREET N.W., SUITE 600, WASHINGTON, DC, 20004, US

(21) Appl. No.: 10/221,023

(22) PCT Filed: Mar. 7, 2001
(86) PCT No.: PCT/US01/04948

(51) Int. Cl. G06F 17/60

(52) U.S. Cl. 705/7

(57) ABSTRACT

This invention provides a novel system and method for bench marking (3) an industry affinity group member against other comparable members, by efficiently gathering information characterizing each member, calculating indicators for each member based upon the data characterizing each member, by comparing the values for the indicators for one member to values for indicators for similar members, and by providing to a user (4) the results of the comparison, and it provides a novel database of information including company (5) information and associated employee status information. In addition, the invention provides means for automatically identifying, offering and selling member improvement products and services to the user (4) based upon the bench mark comparisons. Also available is a peer group forum enabling the user to get self help improvements.

### CROSS REFERENCE TO RELATED APPLICATIONS

This application claims priority under 35 USC 119(e) to United States provisional application attorney docket number 10529-0011-22 PROV filed Mar. 07, 2000, entitled “Collaborative Bench Marking,” and naming Bernard Farkas as inventor, and claims priority under 35 USC 120 to U.S. application Ser. No. 09/556,787, filed Apr. 25, 2000, entitled “Collaborative Bench Marking,” and naming Bernie Farkas as inventor.

### BACKGROUND OF THE INVENTION

1. Field of the Invention

This invention relates to the field of business management. More particularly, this invention relates to intelligent business decisions.

2. Discussion of the Background

An affinity group is a group of entities that have a common type of activity or a common type of interest. Members of an affinity group may include real people and artificial legal entities. Artificial legal entities include for example, corporations, schools, societies, and associations. Artificial legal entities are referred to herein as either organizations or companies. Members of a personal affinity groups include only real people. Members of industry affinity groups include artificial legal entities. Members of a specific industry affinity group include organizations in that specific industry. In addition, members of a specific affinity group may include individuals. For example, both health care companies and doctors may be members of a health care industry affinity group.

The organizations in an industry affinity group may compete against each other in economic, business, legal, regulatory, political, social, and health related activities and interests. However, by definition, organizations in an industry affinity group have common types of activities and interests. The common activities and interests in an industry affinity group include economic and business activity, such as labor competition, labor compensation, inventory management, licensing requirements, overhead, capital improvements, cash flow management, sales, distribution, marketing, product pricing, overhead costs, legal evidentiary issues, legal procedural issues, regulatory compliance, regulatory approval processing, and may also include the political, social, and health activities. Currently there is a lack of generally available information regarding (1) an organization's relative performance relative to the other members of its industry affinity group and (2) relative utility of product and service solutions to problems faced by members of an industry affinity group.

The invention provides a means for companies that compete with one another to disclose valuable operational, financial, purchasing and other business information which companies are currently reluctant to otherwise disclose. This invention addresses the lack of availability to an organization of information about the organization's relative performance in its industry affinity group, the lack of availability to an organization of information showing what processes and practices tend to result in better relative performance in the organization's affinity group, and the lack of availability of information comparing the usefulness of specific products and services directed to improving the organization's processes, procedures, and relative performance. The practices used by organizations having relatively high values for a specified bench mark are termed “best practices” in the financial management art. One of the purposes of this invention is to overcome the disinclination of members of affinity groups to disclose information, to one another. Another one of the purposes of this invention is to overcome the disinclination of members of affinity groups to disclose to one another what processes and practices they use. Yet another one of the purposes of this invention is to overcome the disinclination of members of affinity groups to disclose to one another what products and services they find useful.

### SUMMARY OF THE INVENTION

Accordingly, it is an object of this invention to provide to an organization information about the organization's relative performance in its industry affinity group.

It is another object of the invention to provide to the organization information comparing the usefulness of specific products and services directed to improving the organization's relative performance.

It is yet another object of this invention to provide a method of building a database of company and company employee information.

It is yet another object of this invention to provide a method of building a database of company and company employee information including hierarchical authority of the employees.

It is yet another object of this invention to provide a database of company and company employee information.

It is another object of the invention to provide to the subject organization information showing the best practices used in its affinity group that relate to a specified bench mark.

It is another object of the invention to automatically correlate the organization's practices to its affinity group's best practices.

It is a further object of the invention to automatically identify and display to a user products and services that are intended to improve the correlation of the organization's practices to the affinity group's best practices.

The objects of this invention are achieved by providing a novel computer system and computer implemented method for bench marking an organization against other comparable organizations, by efficiently gathering information characterizing each organization, calculating indicators for each organization based upon the data characterizing each organization, by comparing the values for the indicators for one organization to values for indicators for similar organizations, and by providing to a user the results of the comparison.

In addition, the system provides means for identifying and offering organizational and business improvement products and services to the user, the offerings preferably being automatically selected from a product database based upon the bench mark value comparisons and rules relating the user's selection of bench marks and the values for the bench mark comparisons to products intended to address the organization's needs for improvement.

The information gathered includes specific business practices that each organization uses to implement specified business process. The computer system implements a predetermined correlation of business processes to bench marks. The computer system implements a method of determining best practices for an affinity group by (1) identifying affinity companies, preferably based upon user input of what factors constitute affinity group companies (e.g., number of employees, industry classification, demographic classification by regional cost of living range, cost of floor space range) and (2) identifying a subset of those companies having a bench mark value above a specified value, preferably the user providing the specification, and determining the fraction of that subset of companies using each business practice relating to the business process associated with that bench mark. The practices used by this subset of companies are best practices for the identified affinity companies for the corresponding bench mark.

The computer system may also implement a method of determining correlation between the foregoing best practices data and the business practices used by an organization, automatically identify low correlations of certain practices, or low averages of all correlations for a given process, and automatically identify products and services intended to increase the low correlations.

Thus, the novel system and method of the invention provide a user thereof a novel tool for comparative analysis of the user's organization relative to other organizations in the same industry or cross-comparisons between industries. The system and method advise the user with prescriptions, including available products and services, for improving the user's organization's operating effectiveness based upon the results of the analysis of the values of the organization's bench marks, processes, and procedures, in a regulatory and non regulatory context.

In addition, the use of the system of the invention naturally leads to a novel method of collecting valuable user and company data in a novel database, the database including information defining each company's hierarchical chain of authority, and information for each company identifying each user's job functions, position, and authority in the company's chain of authority. The database also contains company bench mark input data, and company processes and procedures data.

Furthermore, the database may contain company processes and procedures cost data, the cost data including data identifying direct labor and direct labor overhead costs, materials and materials overhead costs, and demographic data providing correlation of labor, material, and overhead costs to geographic location (e.g., floor space costs and labor costs correlated to zip or region code).

Furthermore, the system may provide to a user automated communications (e.g., emails and Web pages not in response to a specific request for information) the contents of which depend upon the user's prior bench marking requests, actions, reactions, related activity, behavior, and habits, including the user's prior responses to such automated communications. The contents and the existence of the automated communications may also depend upon other user's of the same company's prior bench marking requests, actions, reactions, related activity, behavior, and habits, including those users prior responses to such automated communications.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic showing a network of digital computers including computers hosting a novel bench marking computer system of the invention;

FIG. 2 is a high level flow chart of a novel bench mark and business practice processing of the invention;

FIG. 3 is a flow chart of the Welcome Center processes of FIG. 2;

FIG. 4 is a flow chart of the Bench Marking processes of FIG. 2;

FIG. 5 is a flow chart of the Store processes of FIG. 2;

FIG. 6 is a flow chart of Qualified Lead processes discussed for FIGS. 4 and 5;

FIG. 7 is a flow chart of Purchase processes of FIGS. 4 and 5;

FIG. 8 is flow chart of Admin processes of FIG. 2;

FIG. 9 is a table containing data showing bench marks for a company's paid leave benefits;

FIG. 10 is a is a table containing data showing bench marks for a company's paid health and disability benefits;

FIG. 11 is a table containing data showing bench marks for a company's inventory;

FIG. 12 is a table containing data showing bench marks for a company's professional licensing requirements for individuals;

FIG. 13 is a table containing data showing bench marks for a company's paid salaries;

FIG. 14 is a table containing data showing bench marks for a company's sales personnel;

FIG. 15 is a table containing data showing bench marks for a company's standard products;

FIG. 16 is a table containing data showing bench marks for a company's working capital assets;

FIG. 17 is a table containing data showing bench marks for a company's working capital liabilities;

FIG. 18 is an alternative to the benchmark processing center of FIG. 4.

### DETAILED DESCRIPTION OF THE PREFERRED EMBODIMENTS

In the drawings, like reference numerals designate identical or corresponding parts throughout the several views.

Overview of the Bench Marking System

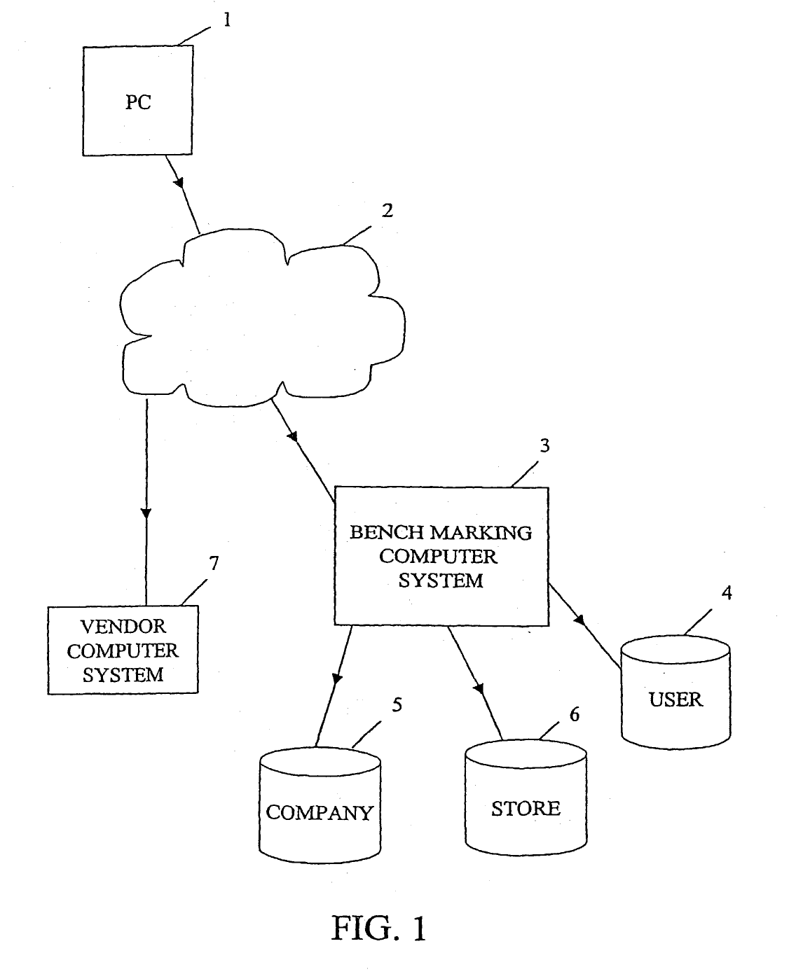

FIG. 1 shows a digital client computer 1, such as a personal computer, containing an electrical power supply; a central processing unit; means for storing and retrieving data from data storage media; data storage media such as random access memory, read only memory, magnetic disk media, optical disk media; user input/output devices, such as a mouse, a keyboard, and a monitor. The client computer 1 is capable of running an operating system, such as a version of Windows or Unix coordinating the activity of the various components of the personal computer. The operating system preferably enables the computer to execute web browser software, such as a version of Netscape Navigator or Internet Explorer so that the client computer 1 functions as a network client. However, the personal computer 1 may alternatively be capable of operating dumb or smart terminal software or any form of continuous session inter computer connection software.

FIG. 1 also shows a network 2, such and the Internet through which the client computer 1 can interact, for example using TCP/IP protocol, with a bench marking computer system 3 and a vendor computer system 7.

The bench marking computer system 3 includes at least one computer running bench marking software. Preferably, the bench marking computer system 3 runs Web server software so it can interact using graphically formatted files with a user of client computer 1.

FIG. 1 also shows the user database 4, the company database 5, and the store database 6 in communication with the bench marking computer system 3. It is to be understood that, although the information about the company, the store, and the user is described herein as being stored in separate databases, the information could all be stored in one or more computer database files, broken down into one or more logical relational database tables with no or appropriate logically linked fields between the tables as is well known in database programming.

The user database 4 stores an identification of each user of the bench marking server system 3 in association with the user's identification: user name, contact information, company identification, company user e-mail addresses, company user contact information, company, hierarchical position within the company, and rights or authorizations to view, use, and change the company data stored in the company database 5.

User log data is also stored, either in the user database or in separate files, and contains a log of user activity in association with a user identification. The log including storage of the user's web pages served by the bench marking computer system, bench marks requested, bench mark results, purchase transactions, links to vendors, and prior automated communications sent to the user.

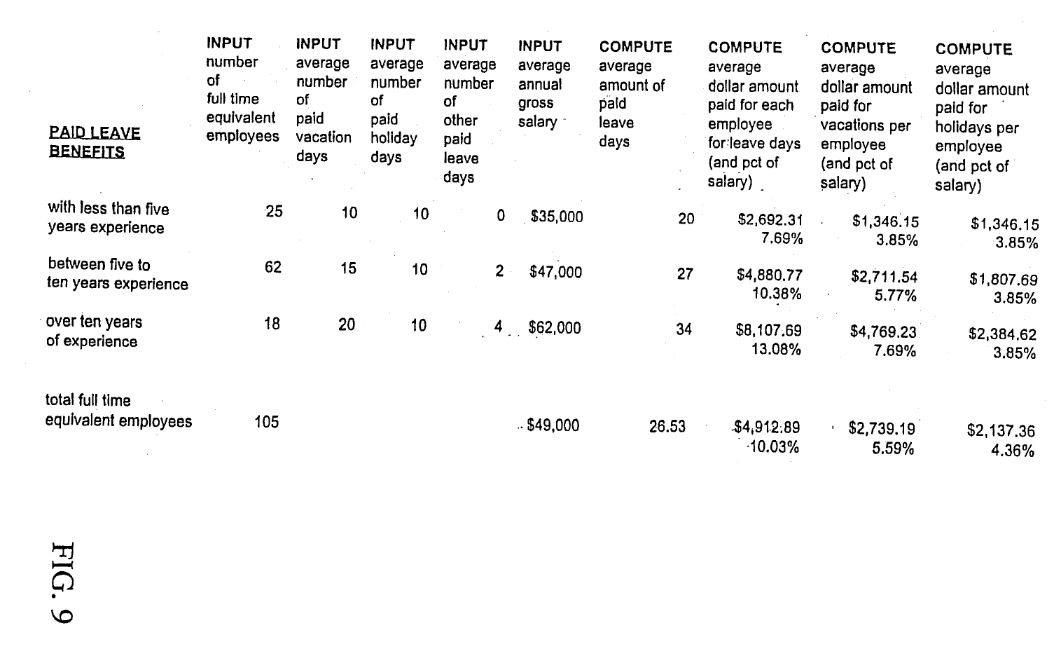

The company database 5 stores identifications of each company associated with a user of the bench marking server system 3 in association with each company's: company industry group, (for example using company or user association membership, Standard Industrial Code (SIC), or NAISC as industry group identifications), or a user's voluntary classification of his company with an industry as the company's industry group identification), bench marking input data (provided by users of the company), dates relevant to the bench marking input data (such as week, month, quarter, or year applicable to the data), calculated bench mark output values based upon the company's input data, rankings of the company based upon its bench mark output values compared to similar companies bench mark outputs. Input data and output bench marks are described in connection with exemplary company bench marks shown in FIGS. 9-17 and discussed hereinafter. Data for each one of the input and output data types described for FIGS. 9-17 may be stored in association with an identification of a company in company database 5.

In addition, database 5 may store company process/practice data. A process herein means a business function that affects an organization's ranking using a bench mark. Thus, a measure of such a process would be an input to a bench mark. A practice herein means an action or activity that occurs in performing a business process. Thus, a business process must have at least one practice used to accomplish the process. For business processes include the salary administration (of both preexisting employees and potential new employees), sales administration, paid leave benefits administration, inventory administration, current assets administration, and current liabilities administration, and health benefits administration many practices may be required for each process. For example, salary administration may or may not include any of the following practices: (1) determination of employee salary changes by line supervisor, top level of management, CEO, and/or HR department, (2) the use in the determination of an industry wide salary database, a company wide salary database, and labor classifications, (3) the use in new hire determination of the foregoing factors and also candidate formal education, (4) employee acquisition practices including use of referrals, advertising, placement agencies, Internet resume agencies, academic institution placement offices, (5) the existence and type of tuition reimbursements practices, the existence and type of bonus plan, stock purchase plan, health insurance, supplemental insurance, and (6) the frequency of off premises work.

In database 5, stored in association with each company's identification are its practices. Each, practice maybe also be associated with one or more than one business process. For example, the same advertising may target both candidates for employment and customers. Accordingly, advertising may be a practice associated with both salary administration and sales administration. FIGS. 19 et seq. are tables which each contain a business practices named in the left hand column. Each row in FIGS. 19 et seq. has a business practice name in the left hand column and the entries in the same row contain possible alternative values for that business practice. There are business process sub headings in bold, such as “Salaries” at the top of FIG. 19, which each indicate that the subsequent columns contain business practices associated with that business process.

The store database 6 stores identifications and descriptions of products and services, each product or service is preferably stored in association with identifications of or flags for related bench marks, at least one ranking relative to other products in the same product class for each bench mark, price, and purchase information. The purchase information includes at least one of an address for a link to the store's own purchase system, contact information, such as a URL for a main Web page of a vendor of the product or service or a URL for a Web page of a vendor's Web site offering for sale the product or service, or physical address and telephone contact information for the vendor of the product or service.

Overview of the Method of Use of the Bench Marking System

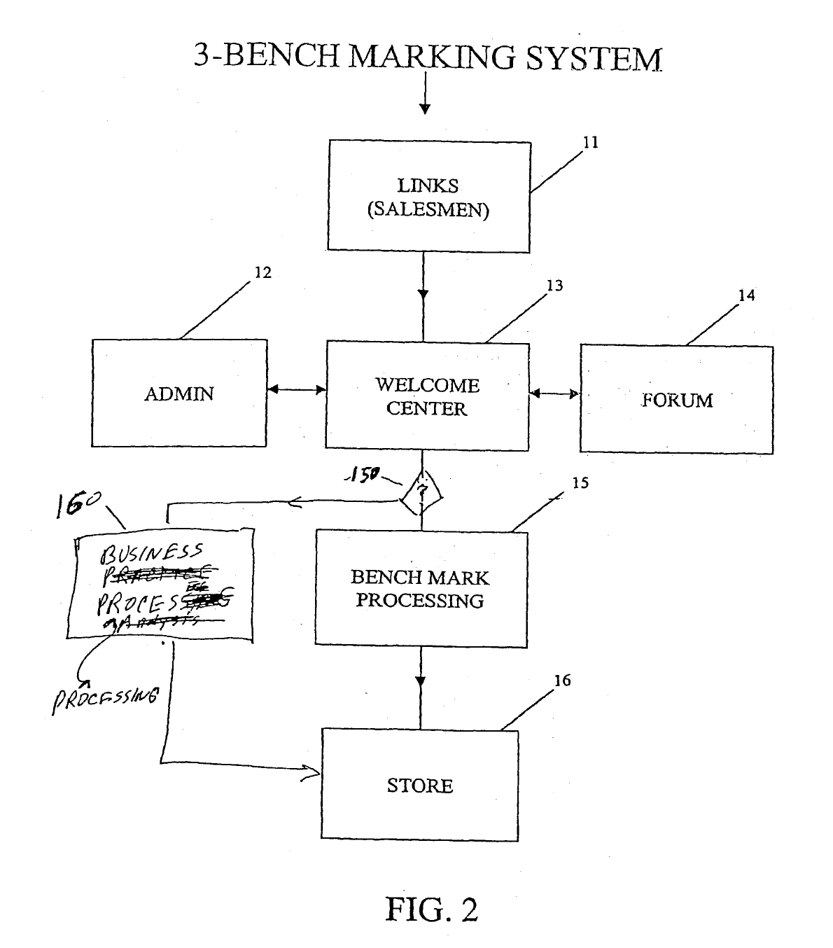

FIG. 2 illustrates an overview of an process of use of the bench mark computer system 3 communicating via the network 2 with a user's client computer 1. The user either points the browser of the client computer 1 or clicks a link in a Web site that points the browser to the main page of the welcome center 3. While a specific process flow of the user's client computer to Web pages of the bench marking Web site provided by the system 3 will be described, it is understood that Web pages served to the user's client computer 1 often contain a plurality of links to various Web pages provided by the computer system 3 in addition to the Web pages of the specific process flow to be described, and the Web pages (including templates) that can be provided by the system 3 are referred to herein as the bench marking Web site.

FIG. 2 illustrates an overview of a process of using the bench marking Web site in which the user links from one of links in step 11 from some other Web site to the main page for the welcome center 13. (The links 11 are the computer analog of salesmen in a brick and mortar store.) In step 13, from the welcome center, the user preferably (by clicking appropriate links on pages served to the client computer 1) navigates to the bench marking center. In step 150, the user chooses (by clicking appropriate links on pages served to the client computer 1) to obtain bench mark analysis or business practice analysis. In step 15, at the bench marking center in step 15 where the user enters bench mark input data on the user's company, obtains bench mark output data on the user's company (i.e., values for bench marks), obtains prescriptions for the user's company based upon the bench mark output data. In step 160, at the business practice processing center 160, the user enters business practice data for the user's company, obtains best practices information for the user's company's affinity group, and obtains correlations between the best practices and the user's company's practices. In step 16, at the store, the user purchases prescribed products or services that were prescribed to the user based upon the results of the bench mark analysis or the best practices analysis.

In addition, in response to predetermined conditions, the bench marking computer system 3 directs the client computer to the admin 12 for the user to input and update user information, input and update company data, and obtain and provide authorization for data input and data access to the bench marking Web site and user and company databases of system 3. Moreover, certain Web pages served to the user throughout the bench marking Web site contain links to the forum 14 where the user may engage in electronic multimedia, image, and voice exchange and discussions with his peers by uploading and downloading data.

Welcome Center Processing

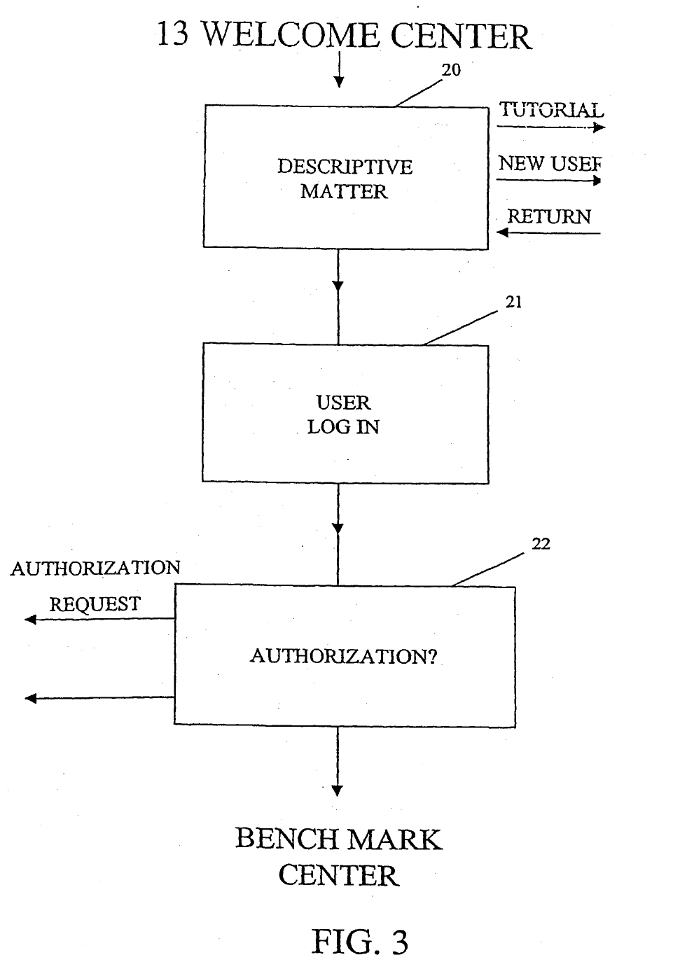

FIG. 3 shows details of the process of use of the welcome center 3. In step 20, the system 3 displays the main page of welcome center 3. The main page of the welcome center 3 contains descriptive material about the bench marking Web site, preferably containing a link to a Web page providing a tutorial on use of the bench marking Web site, a link to the user log in page (see step 21), and a link to a new user registration page.

The descriptive matter in the welcome center main page may include the following items: description of the functions of the bench marking Web site provides, how the bench marking Web site works, a solicitation to type in e-mail addresses of other members of the user's organization so that the Web site can send e-mail to those e-mail addresses soliciting queries, explanations of why it is important for the user to register, forms requesting suggestions or criticisms, forms allowing completion of the input of corporate information, forms allowing completion of the input of individual registration information, if not yet complete.

New User Registration

The new user registration page provides a form enabling the user to enter certain information, including for example, user name, password, company e-mail address, member number (representing a user's company member number), company fax number, company name, company telephone number, company mailing address, and the user's company title. The information that the user enters about the user is stored in the user database 4.

The bench marking computer system 3 determines from the information provided by the user if the user's company is not a member. If the user's company is not a member, the system 3 sends the client computer 1 a Web page containing a form soliciting the user's company to become a member, and subsequent Web pages containing forms requesting company registration information, such as company industry, names of authorized personal and their levels of authorizations and hierarchical positions (e.g. member of Board of Directors, Chief Executive Officer, Corporate Officer, Vice President, Director, Department Supervisor, team Supervisor).

If the user declines to register the use's company as a member, the system 3 may provide a Web page to the client computer 1 offering the user, for example, a data subscription (e.g., a one time fee to see the results from ONE DATA set), or a subscription for some specified period of time, a request to identify a sponsoring organization and that organization's authorization number for providing either limited or full access to the Web site, and an option to join an association (industry network) providing for the user free access to the bench marking Web site.

Once the user has navigated through the welcome center 13 the user is presented a Web page containing links to the bench center 15, the forum 14, the store 16, and in some situations (e.g., if the user has rights to modify data for the user's company) to the admin 12.

User Log In

In step 21, the system transmits a user log in page to the client computer. A preregistered user can log on (e.g., by entering a user name and password) and then proceed to the bench marking center 15, the forum 14, or the admin 12. If the user is not preregistered, the user may only be allowed to receive the new user registration page.

Step 22 is an optional step which may be required if the user has registered but is not authorized to access certain portions of the bench marking Web site. After the user has completed inputting his information in the user information step 21, in step 22 the system 3 queries the user database 4 to determine (1) whether the user is authorized to access the Web site and (2) if so authorized, what information the user is authorized to access. For example, a President, Chief Executive Officer, or member of a Board of Directors of a company may be authorized to access all information regarding that company. However, a Department Head of a company may only be allowed to access information regarding that department. For example, a user identified as a head of accounting department may not be authorized to access information regarding a company's sales. Per contra, a user identified as a head of a company's sales department may not be authorized to access a company's accounting department. Accordingly, the user database contains an association for each user of data for the user's company to which the user is entitled to obtain access.

If querying of the user database 4 indicates that the user is not authorized to access the Web site, the system 3 may provide a page to the user soliciting the user to obtain authorizations, which is part of the function of the admin 12.

Bench Marking Processing

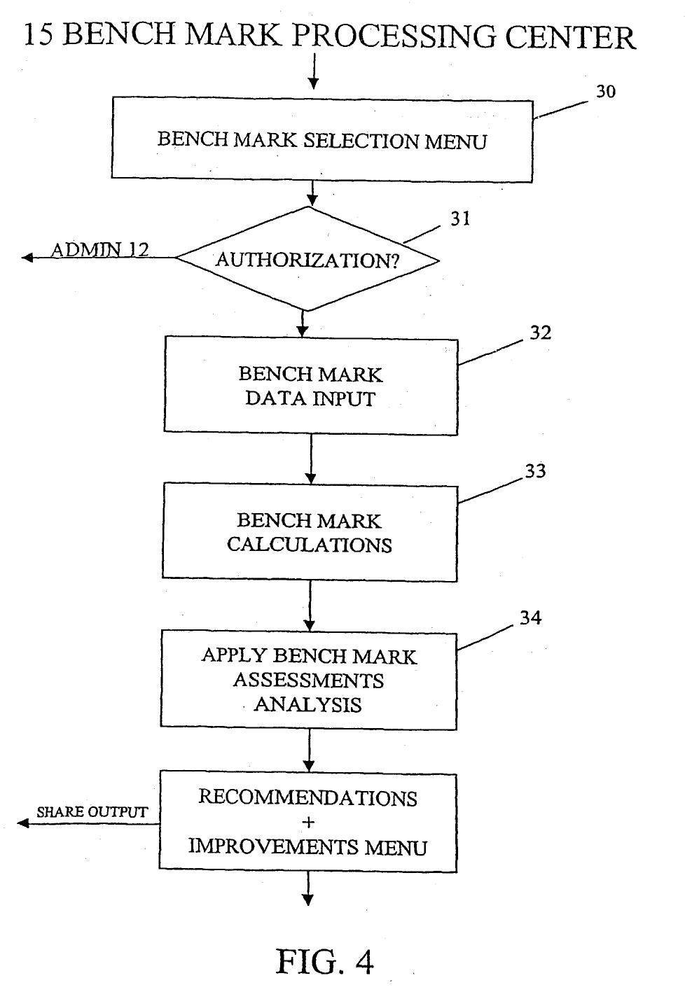

FIG. 4 shows details of the process of use of the bench mark processing 15. In step 30, the system 3 transmits the main Web page of the bench mark processing to the client computer 1. The main pages of the bench mark processing displays a menu of links for bench mark indicators, and user clicks a selected bench mark link.

In step 31, the selection of a bench mark link from the menu may, depending upon the selection, initiate an authorization step, in which the computer system 3 determines whether the user has sufficient authority to obtain the selected bench mark. The determination may be made based upon data for the user stored in the user database 4. If the user is not authorized, the client computer 1 is linked to the admin 12 where the user is provided with selections for obtaining authority.

In step 31, the selection of a bench mark link from the menu may, depending upon the selection, also initiate an authorization step in which the system 3 determines whether the user has sufficient authority to amend input data for the selected bench mark in stored in the company database 5 for the user's company. If the user does not have sufficient authority to amend input data for the selected bench mark stored in the company database for the user's company, the computer system 3 may send the client computer 1 a Web page containing a link to the admin 12 in order to allow the user to attempt to obtain authorizations to amend the data and an alternative link to continue with the bench mark processing, without authorization for storing the user's input data for the user's company in the company database 5. If the user does not have sufficient authority to amend company data for the selected bench mark, the output of the bench mark analysis will contain an indication that the data is invalid and/or unreliable and that the data will not be stored in the company database. Alternatively, the user may indicate, via an appropriate entry, that the data the user inputs is not to be used to amend the company database data, which is useful because it enables the user to obtain bench mark results on hypothetical scenarios. Moreover, the system may provide a means to limit the number of hypothetical scenarios, for example, to ten per user, or to ten per user per user session, in order to prevent a user from effectively copying the data in the company database, product data in the product database, or rules used to provide product suggestions based upon bench marking inputs. If the user links to continue with the bench mark processing, processing continues but the data input by the user and output by the system 3 as part of that processing is not permanently stored in the company database 5.

In admin 12, if the system 3 determined that the user did not have sufficient authorization for the specified bench mark process flow, the system serves the client computer 1 a Web page instructing the user on obtaining authorization. The instructions may include a request for the system 3 to send an email instruction to an another member of the user's company who has the right to provide authorization and requesting authorization for the user, or to that other member to input the data required by the non-authorized user. For example, the sales manager of a company may not be authorized to input accounting data for that company. The sales manager for a company may not be authorized to input sales data for the company. The sales manager for a company may not be authorized to change data indicating commissions for sales for a company. The authorizations provided to a user depend upon the authorizations that user has been assigned according to the chain of authorizations provided by the supervisory chain of the company. The supervisory authorization chain for each company may be stored in the company database 5, and/or as authorization data stored in the user database in association with each user identification.

The system may periodically, or aperiodically and depending upon user log files for user's of one company, email to a user having a supervisory authorization a query on changing authorizations for users of that company. In addition, the system may periodically, or aperiodically and depending upon user log files for a user email to the user information including identifications of products and services for a particular bench mark that are currently available in the store but that were not available in the store, or were not presented to the user, when the user performed the particular bench mark analysis.

In step 31, if the system 3 determines that the user has sufficient authorizations for the process flow for the selected bench mark, the user is prompted in step 32 for input data for the selected bench mark or business process. The user inputs data in response to this prompt. For example, the input data may be bench mark input data for bench marks for one of paid leave benefits, paid health and disability benefits, inventory, professional licensing requirements, salaries, sales personnel, standard products, working capital asset items, and other indicators of company performance. The benchmark input data for these bench marks is shown in FIGS. 9-17 and described in the descriptions of those figures. For example, bench mark data inputs for the salary benchmark are, for example, the number of employees of the company, the average number of years of experience per employee of the company, and the average gross salary of an employee of the company.

Authorization decisions may be automatically based at least in part upon a user's log file history data.

In step 33, the system 3 calculates at least one bench mark output based upon the data entered by the user. If the user has sufficient authorization to change the inputted company data in company databases, the system 3 may update the company's record in the company database 5 with the input data input by the user.

In step 34, the system 3 compares the bench mark output values for the user's company against bench mark output values other companies, and more particularly against other companies in the same industry grouping. The system 3 determines whether the user's bench mark output values are outside a norm for that industry group. This determination may include calculating statistical means, and deviations, for (1) the same benchmark data for companies in the same industry group and (2) for the entire universe of companies stored in the user database. Moreover, the system 3 may compare the benchmark data for the company to the statistical values for the same benchmark for other industry groups.

In step 35, the computer system 3 exercises rules depending upon the selected bench mark, and preferably depending upon the results of the comparison of the company's selected bench mark values to bench mark values for other companies, to (1) display recommendations and (2) display selected products and services stored in the store database 6. The computer system 3 transmits a Web page to the client computer 1 preferably displaying the bench marks output values, the industry group comparisons, and prescriptions for corporate improvement, and the selected products and services. The products and services displayed are intended to be products and services specifically useful to the user or the user's company with respect to the selected bench mark. The displays include industry group averages, rankings of the subject company within its industry group, whether the company meets a predetermined standard (e.g., ranking above 60%), the population of companies upon which the industry ranking is based. Moreover, the display of products and services may itself be ranked based upon price, a combination of price and an objective measure of utility for each product or service, for example provided by user feedback. Recommendations and ranking may depend upon the user's log file data including purchase history data, bench mark results, and user's input of budget and time constraints. The user may able to specify budget and time constraints wither prior to or after bench marking. The In addition, the recommendations may be divided by product category. Product improvement categories are, for example, software solutions, books and videos, newsletters, education and testing services, etc.

Alternatively, instead of ranking, the bench marking web site may simply display the bench mark results and list products and services in the store from a category, the category being based upon the selected bench mark.

Examples of product improvements offered to a user in response to marginal or deficient benchmark data determination are provided below. However, there are many other rules defining high rankings for product and service improvement offers based upon bench mark data.

Working Capital Asset Items

A benchmark ranking which indicates a relatively high level of “current assets”, that is, Accounts Receivable generates a high ranking for a business improvement of: getting a “revolver loan facility” to free up cash, from a vendor in the business of extending credit on accounts receivables. Preferably, the vendor is a vendor affiliate of the bench marking web site. This business improvement would be displayed to the user.

Working Capital Liability Items

A benchmark ranking which indicates a very low “working capital ratio” (much less than 1:1) generates a high ranking for a business improvement of: getting an “equity cash infusion”, from a vendor in business of making investments. Preferably, the vendor is a vendor affiliate of the bench marking web site. This business improvement would be displayed to the user.

Sales Personnel

A benchmark ranking which indicates a very low level of “bookings per sales person” generates a high ranking for a business improvement of buying a series of “sales training video tapes”; from a vendor who is in business of providing seminars and training for sales and customer service personnel. Preferably, the vendor is a vendor affiliate of the bench marking web site. This business improvement would be displayed to the user.

Paid Leave Benefits

A benchmark ranking which indicates a very high level of “vacation costs per employee” generates a high ranking for a business improvement of: getting a more effective “fringe benefit package” from a vendor who is in business of providing consulting services for setting up effective human resource programs. Preferably, the vendor is a vendor affiliate of the bench marking web site. This business improvement would be displayed to the user.

Health and Disability Benefits

A benchmark ranking which indicates a very high level of “group health costs per employee” generates a high ranking for a business improvement of: getting a more effective “group health plan” from a vendor who is in business of setting up and providing health insurance. Preferably, the vendor is a vendor affiliate of the bench marking web site. This business improvement would be displayed to the user.

Salaries

A benchmark ranking which indicates a very high level of “salary costs per employee” generates a high ranking for a business improvement of: acquiring “temporary or day workers” from a vendor partner who is in the business of finding competent temporary workers which reduces a company's “down time”, which reduces the overall salary costs of a company. Preferably, the vendor is a vendor affiliate of the bench marking web site. This business improvement would be displayed to the user.

Inventory

A benchmark ranking which indicates a very low “inventory turnover rate” generates a high ranking for a business improvement of: selling or buying inventory from a “excess inventory exchange” operated by a vendor who is in business of operating a network of related industry companies for the purpose of reducing inventory levels of its members. Preferably, the vendor is a vendor affiliate of the bench marking web site. This business improvement would be displayed to the user.

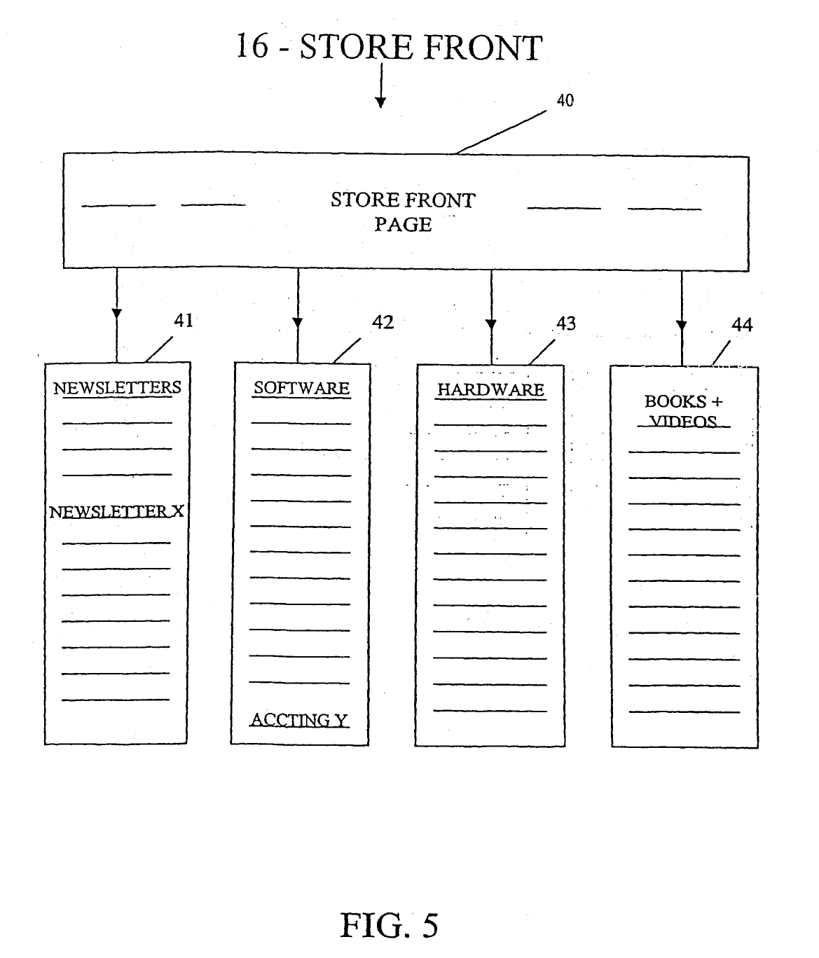

The products and services displayed in step 35 may be based upon a set of rules that relate (1) products and services identified in a database associated with the store 6, associations of those products or services in the database with the subject benchmark, and an association of products and services with different rankings of benchmarks in an industry. For example, if the company's salary benchmark indicated that the company was in the 95 th percentile in salary (i.e., paying very high salaries), and if a rule existed indicating that software was the most useful type of product addressing salary ranking above the 90th percentile, the system 3 would invoke the rule identifying software solutions for display, and then invoke a rule identifying software products and services identified in store database 6 directed to limiting salary growth. Each display of a product or a service is associated with a link to a purchase offer or a qualified link for the product or service, as discussed below with respect to FIGS. 5-7.

FIG. 5 shows a sequence of steps relating to the use of the store 6. From anywhere in the bench marking Web site, the user may click a link connecting to a store front main page.

In step 40, the system 3 provides to the client computer 1 the store front main page. The store front main page displays product and service category links, such as links for newsletters, software, hardware, and books and videos. The user selects one of the identified links, such as the links for newsletters.

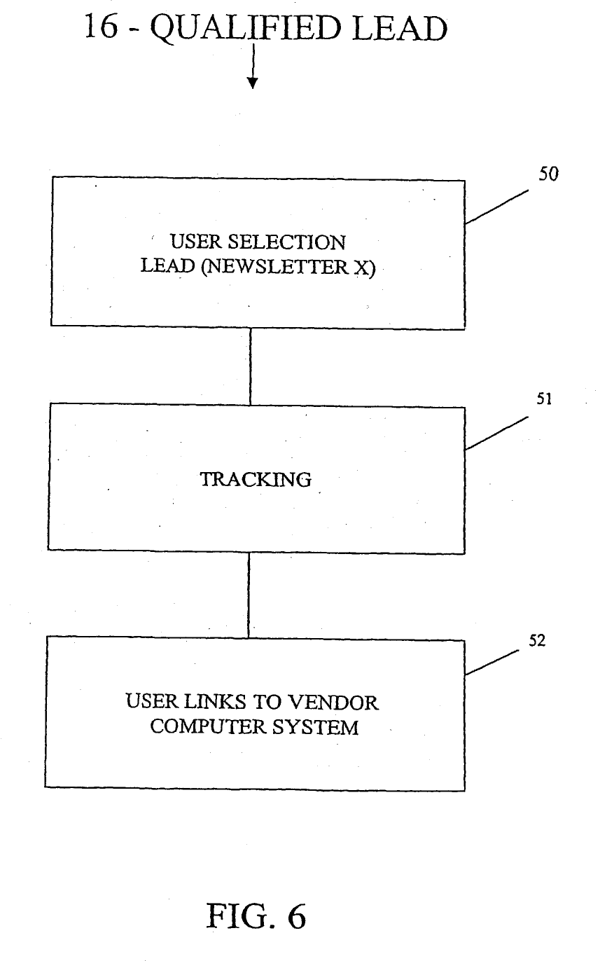

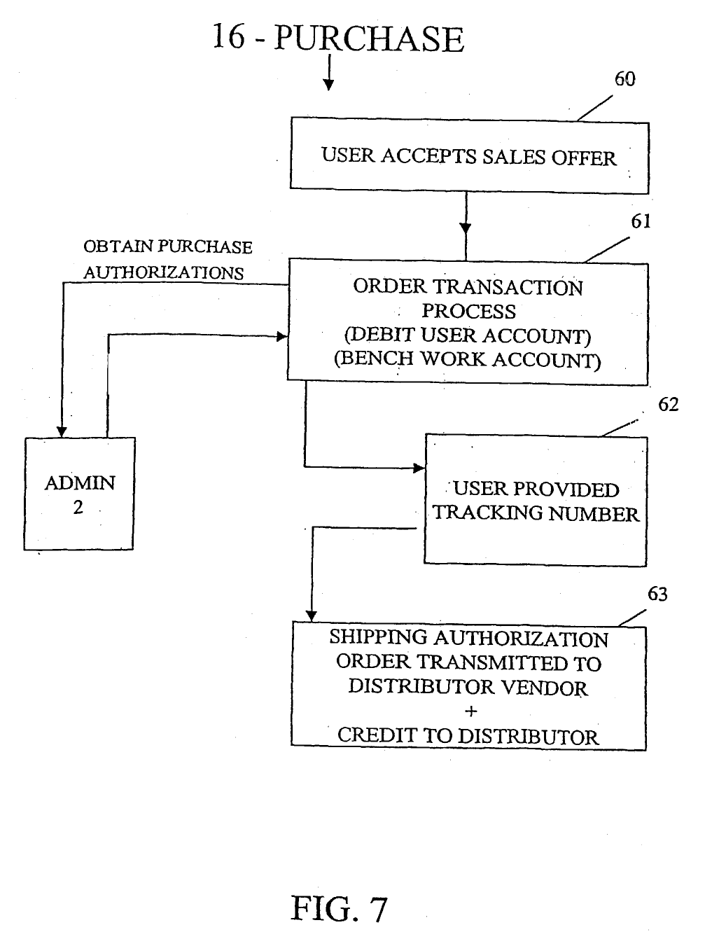

In step 41, the system 3 provides a display to the user of specific newsletter products. In step 41, for example, the user can select to purchase (or to obtain additional material regarding) newsletter X by clicking on a link identifying newsletter X. The links provided by the system 3 in steps 41-44 are either (1) qualified lead links which are described in FIG. 6 or (2) sales offer links which are described in conjunction with FIG. 7. In each one of steps 41-44, the system 3 transmits to the client computer 1 a Web page displaying links for one of the newsletters, software, hardware, and books and videos. However, other product and service categories can be displayed.

FIG. 6 shows a sequence of steps that occur when a user clicks a qualified link at any of steps 41-44.

In step 50, the user selects a link for a product or service, or clicks a qualified lead link from the links displayed in step 35 as a result of a bench marking function. For example the user may click the link displayed in step 41 as a request to purchase newsletter X.

In step 51, the computer system of the Web site generates a tracking number for that transaction, provides the tracking number to the user, and/or redirects the user's browser to a URL for a distributor of newsletter X, such as a URL for vendor computer system 7 of FIG. 1.

In step 52, the user's browser interacts with a Web site of the distributor of newsletter X, resulting in a purchase transaction in which the user purchases a subscription to the newsletter X. Subsequently, the distributor may pay the owner of the system 3 a referral fee based upon the qualified lead provided by the system 3.

FIG. 7 shows a sequence of steps that occur when a user purchases a product or service from the store 6. That may happen in response to the user drilling down from the main page of the store 6 (steps 40-44) or from the user clicking a link to a product or service displayed in response to a bench marking analysis in step 35.

In step 60, for example, the user clicks the link for the accounting Y software package displayed in step 42. That action initiates an order transaction process step 61. The order transaction process involves debiting the user's account and crediting the bench marking Web site's account for the cost of the accounting software. In step 62, the user is provided with a tracking number for his purchase.

In step 63, the system 3, generates a shipping authorization order and transmits that order to the distributor or vendor, and credits the distributor or vendor's account.

The ability of the user to browse through descriptions of products offered from a plurality of vendor organizations, but targeted to the user's needs as determined based upon the bench mark results, and to do so by viewing Web pages transmitted from the bench marking web site, before linking to the vendor's Web site (or purchasing the product directly from the bench marking Web site), enables the users to efficiently compare competing products when attempting to decide what to purchase.

Admin—Database Maintenance

The admin 12 facilitates maintaining the user database 4 and the company database 5, by soliciting information from the users, storing that information, and generates email transmissions as part of that process to other members of the user's organization.

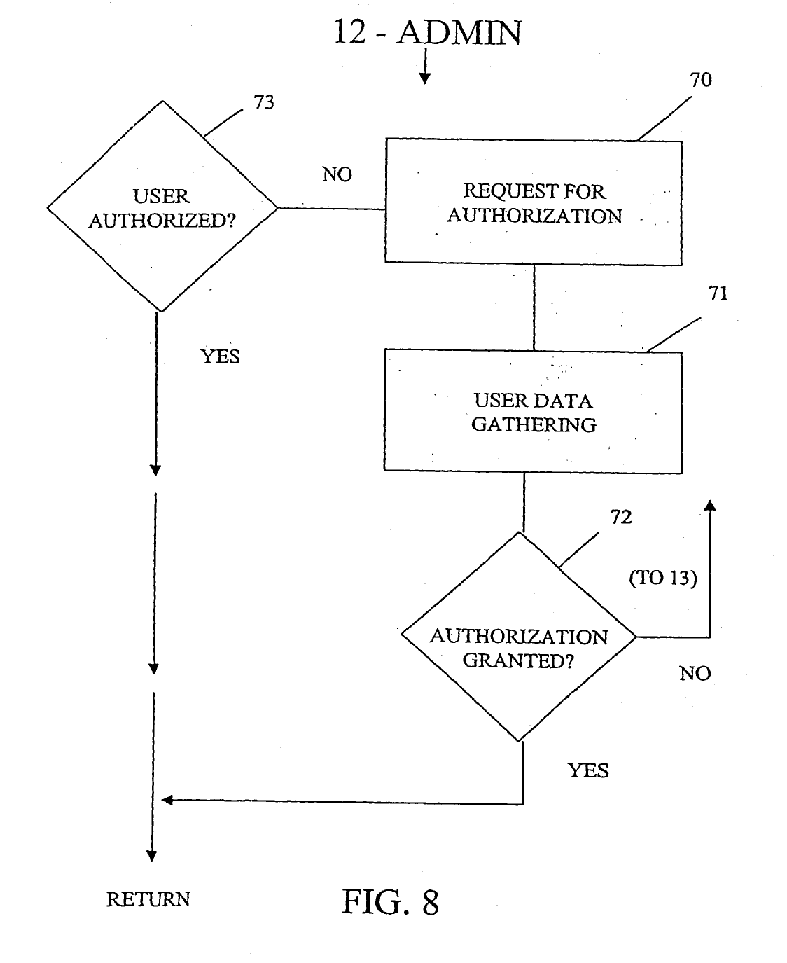

FIG. 8 shows a sequence of steps that occur in the admin 12 in FIG. 2. The admin 12 provides means for facilitating administration of the user database 4 in the company database 5 by the users of the bench marking computer system 3. At several steps throughout the use of the bench marking computer system 3, the system displays to the user links to the admin 12. Those steps are represented schematically by decision step 73 in which the system 3 determines whether the user has appropriate authorizations.

FIG. 8 shows flow in the admin 12, in which the system 3 serves the user's client computer a series of Web page enabling the user, depending upon the user's rights and authorizations, to update the user's information, other user's information, and the user's company data in the user and company databases 4 and 5.

In step 70, the system 3 transmits to the user requests for information required for authorization. In addition, in step 70, the system 3 may transmit (e.g. via email) requests to representatives of the users company other than the user to provide to the user the authorizations necessary for the user to proceed with the user's selected action in the bench marking Web site. For example, the system 3 may transmit an email to an authorized member of the users company with a request to authorize the user for the user's selected activity, and that request may include a request for additional information on additional members of the users company who should be granted authorization. Thus, in step 70, the system gathers both information necessary to authorize the user in the users selected activity, and may receive additional data.

In step 71, the system 3 stores the data gathered in step 70 in the user and company databases 4 and 5, as appropriate.

In step 72, the system 3 determines whether the user has been granted authorization to proceed. If the user has been granted authorization to proceed with the users selected processing, the system 3 may return the user to the process step that occurred prior to when the user linked to the admin 12. Alternatively, the admin 12 may transmit to the user a page containing links, including for example a link to step 30 in which the bench mark selection menu is displayed to the user.

In step 72, if the system determines that the user has not been granted authorization, the system may transmit to the client computer 1 a page containing links for the main page for the welcome center 13 and the forum 14.

The forum 14 contains a main page providing links to sub-pages that may contain discussions of products provided by the store 6, requests for information of the users segmented by defined categories, and other information deemed useful to the user in deciding whether and what type of products to obtain for the user's company.

The forum 14 is important because it provides a venue for users to communicate with one another, particularly for users in the same affinity group to share information and experiences and insights, thereby self promoting certain products perceived by users to be effective. Moreover, the forum may be seeded with a directory of peer who may be available to the users for advise and counsel.

Examples of Bench Marks

FIGS. 9-17 illustrate data for exemplary industry affinity group bench marks. The bench marks discussed for FIGS. 9-17 are non regulatory bench marks based upon non regulatory activities of the company.

FIG. 9 shows bench marks for paid leave benefits for employees, for example, as a function of the number of years of experience of the employee, (e.g., paid leave benefits for employees at the company with less than 5 years, paid leave benefits for employees at the company with between 5 and 10 years' experience, and paid leave benefits for employees with over 10 years' experience). Each year of experience range constitutes a different bench mark input parameter.

The paid leave benefits for employees input data for these bench marks includes: number of equivalent full-time employees at the company, average number of paid vacation days per employee as a function of years of experience, average number of paid holidays as a function of years of experience, average number of other paid leave days as a function of years of experience, average annual gross salary as a function of years of experience, average amount of paid leave days as a function of years of experience.

The paid leave output data, which are the bench marks for that company, include: average dollar amount paid for each employee for leave days as a function of years of experience, average percent of salary paid for each employee for leave days as a function of years of experience, average dollar amount paid for vacations per employee as a function of years of experience, average percent of salary paid for vacations per employee as a function of years of experience, average dollar amount paid for holidays per employee as a function of years of experience, average percent of salary paid for holidays per employee as a function of years of experience. It is to be understood here that the meaning of a function of years of experience implies averages over ranges of years of experience as shown in the row headings in the left hand column in FIG. 9.

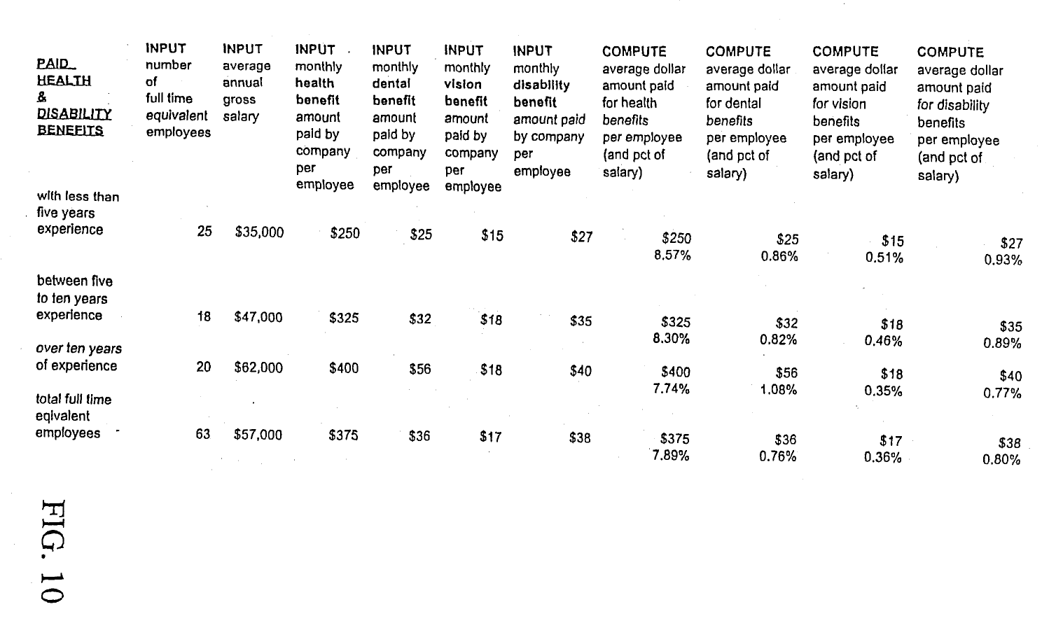

FIG. 10 shows bench marks for paid health & disability benefits for employees as a functions of the number of years of experience of the employee, (e.g. paid health & disability benefits for employees at the company with less than 5 years, paid health & disability benefits at the company with 5 to 10 years' experience, and paid health & disability benefits for employees with over 10 years' experience). Each year of experience range constitutes a different bench mark input parameter.

The paid health & disability benefits input data for these bench marks includes: the number of equivalent full time employees at the company, average annual gross salary per employee as a function of years of experience, monthly health benefit amount paid by company per employee as a function of years of experience, monthly dental benefit amount paid by company per employee as a function of years of experience, monthly vision benefit amount paid by company per employee as a function of years of experience, monthly disability amount paid by company per employee as a function of years of experience.

The paid health and disability benefits output data, which are the bench marks for that company, include: average dollar amount paid for health benefits per employee as a function of years of experience, average percent of salary paid for health benefits per employee as a function of years of experience, average dollar amount paid for dental benefits per employee as a function of years of experience, average percent of salary paid for dental benefits per employee as a function of years of experience, average dollar amount paid for vision benefits per employee as a function of years of experience, average percent of salary paid for vision benefits per employee as a function of years of experience, average dollar amount paid for disability benefits per employee as a function of years of experience, and average percent of salary paid for disability benefits per employee as a function of years of experience.

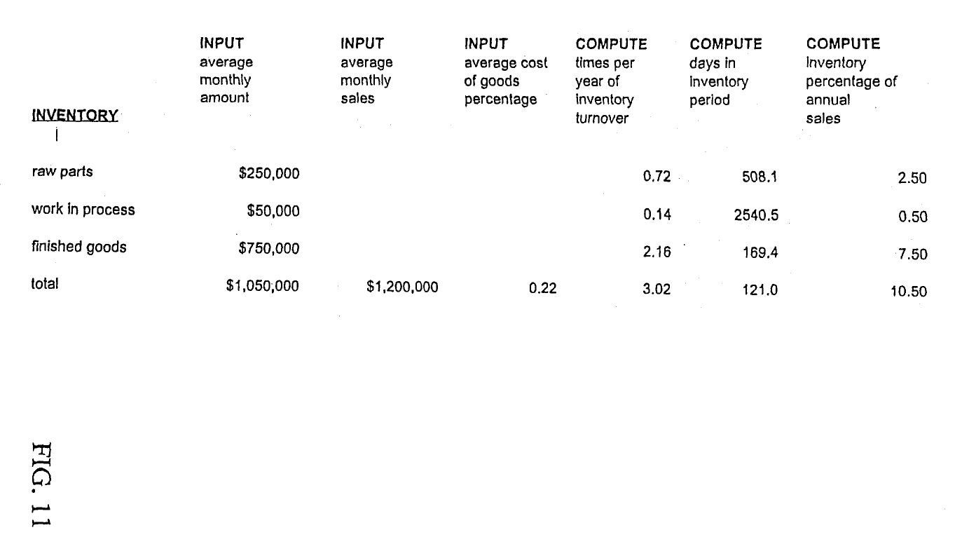

FIG. 11 shows bench marks for different types of inventory, including raw parts, work in process, finished goods, and total inventory.

The inventory input data for these bench marks include: the average monthly dollar amount for each inventory type, the average monthly dollar sales for the total inventory, the average cost of goods percentage for total inventory,

The inventory output data bench marks include: times per year of inventory turnover for each inventory type, days in inventory period for each inventory type, and inventory percentage of annual dollar sales for each inventory type.

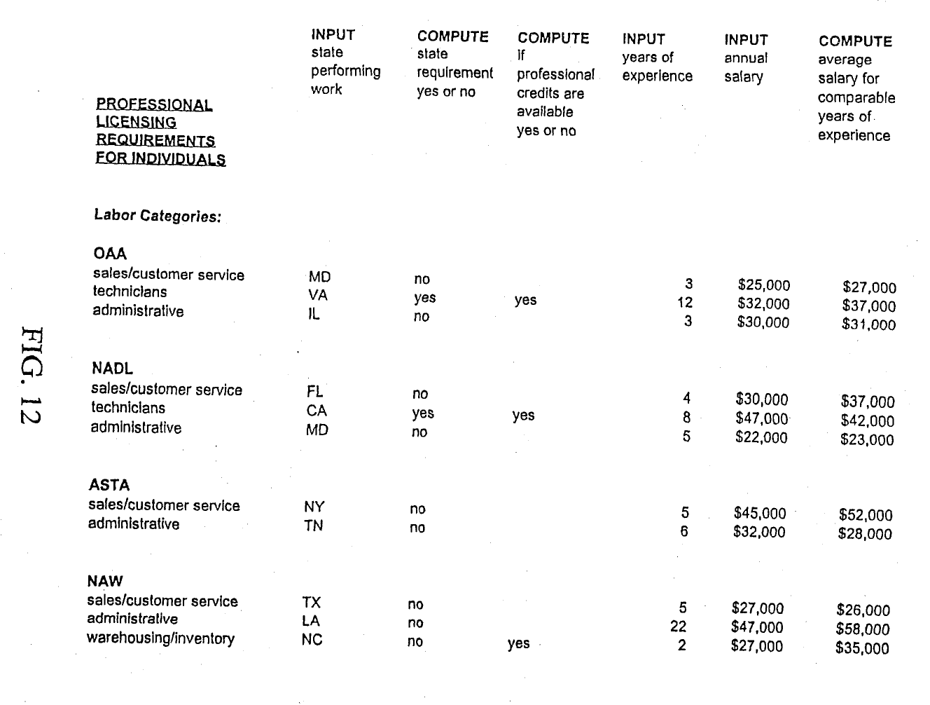

FIG. 12 shows bench marks for professional licensing requirements for individuals, in labor categories including for sales/customer service, technicians, administrative, and warehouse personnel, for various industries, such as the opticians, dental labs, travel agencies, and supply chain industries.

The professional licensing input data for these bench marks include: state in which work is performed.

The licensing output data include: existence of a state license requirement, years of experience, and annual salary. The professional licensing outputs data bench marks include: the existence of a state licensing requirement, the availability of professional credits, and average salary for comparable-years of experience.

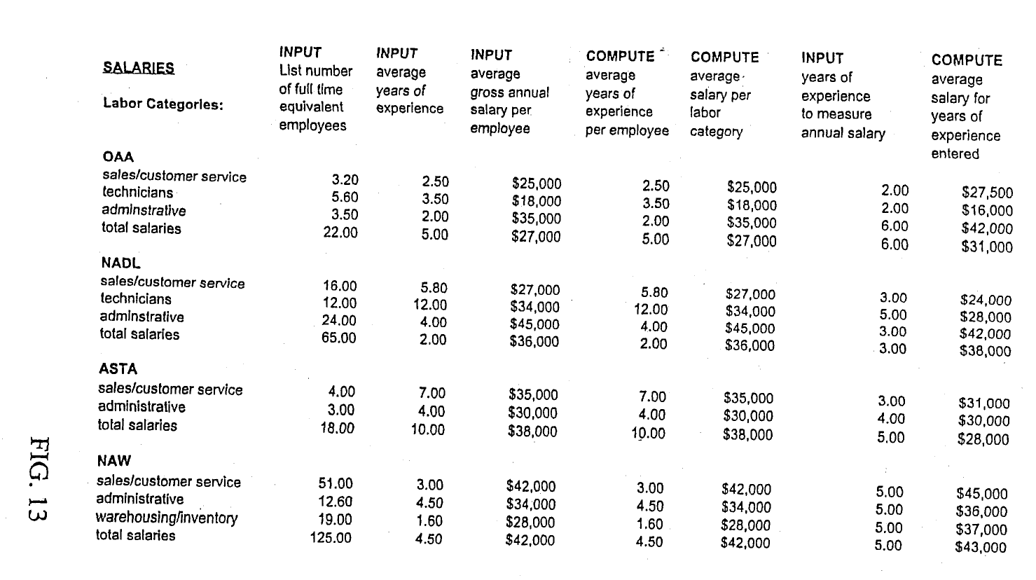

FIG. 13 shows bench marks for salaries categorized by labor categories including but not limited to sales/customer service, technicians, administrative, and warehousing/inventory.

The input data for salary bench marks includes: number of equivalent full time employees, average years of experience, average gross annual salary per employee.

The salary bench mark output data include: average years of experience per employee, average salary per labor category, average salary for years of experience entered.

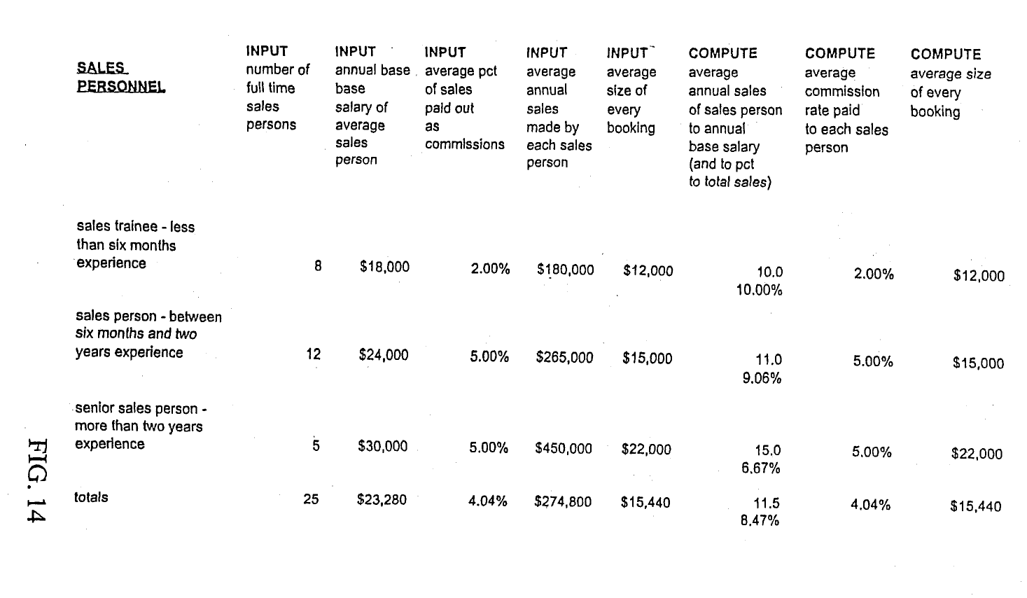

FIG. 14 shows bench marks for salaries categorized by sales personnel and their level of experience, for example sales trainees with less than 6 months experience, sales persons with between 6 months and 2 years experience, senior sales persons with more than 2 years experience.

The input data for sales personnel bench marks includes: number of full time sales persons, annual base salary of average sales person, average percent of sales paid out as commissions, average annual sales made by each sales person, and average size of every booking.

The bench mark output data for sales personnel include: the ratio of average annual sales of salesperson to annual base salary, the average annual sales of salespersons to percent of total sales, the average commission rate paid to each sales person, and the average size of every booking.

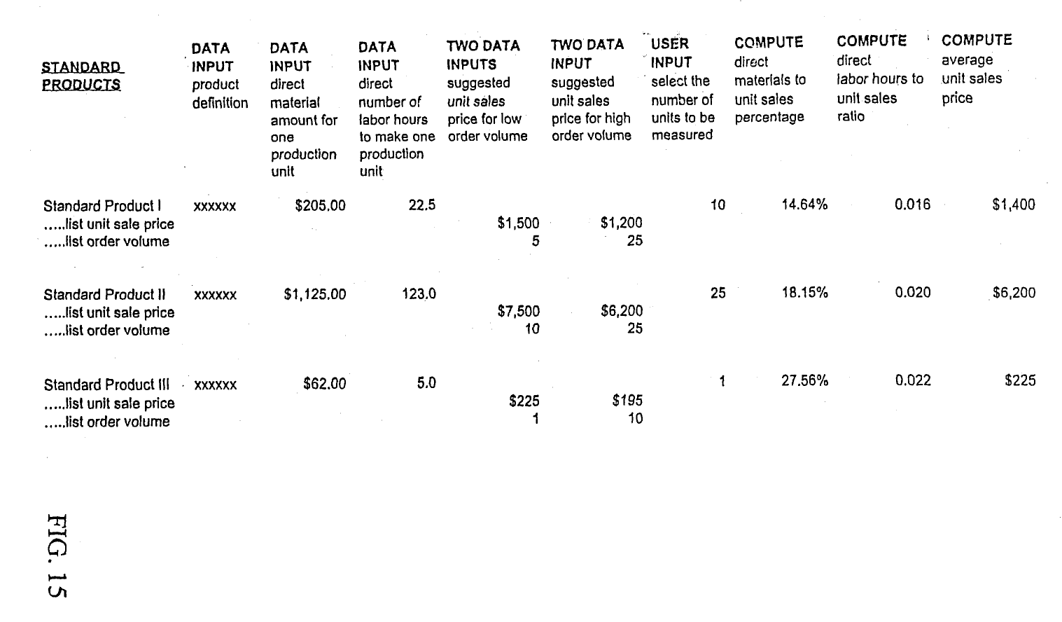

FIG. 15 shows bench marks for multiple standard products each categorized by list unit sale price and list order volume.

The standard product input data include: product definition, direct material costs for one production unit, direct number of labor hours to make one production unit, suggested unit sales price for low order volume, suggested unit sales price for high order volume, selected number of units to be measured.

The bench mark outputs for standard product inputs include: ratio of direct materials to unit sales percentage, ratio of direct labor hours to unit sales ratio, average unit sales price.

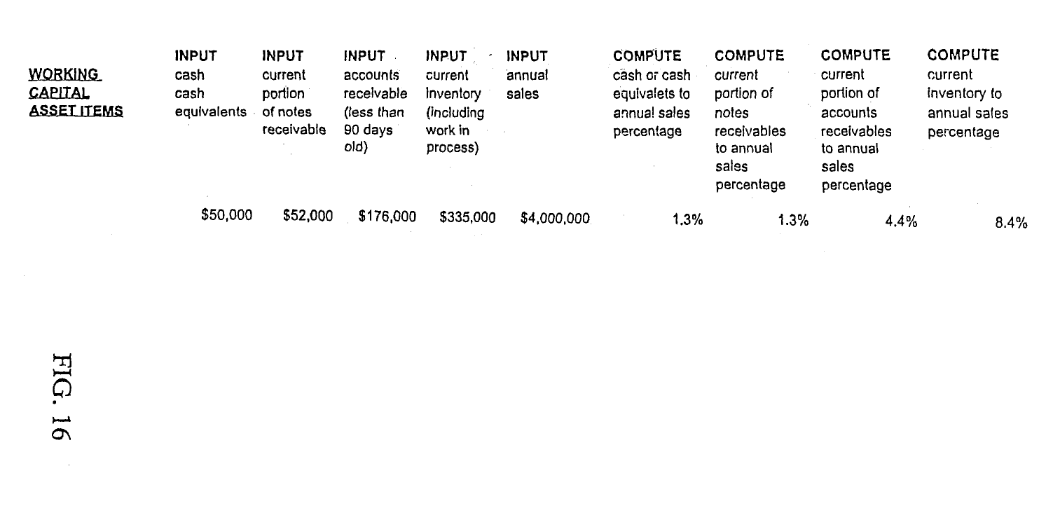

FIG. 16 shows bench marks for working capital asset items.

The bench mark input data for working capital assets include: cash or cash equivalents, current portion of notes receivable, accounts receivable that are less than 90 days old, current inventory including work in process, and annual sales.

The bench mark outputs for working capital asset items include: ratio of cash or cash equivalents to annual sales percentage, ratio of current portion of notes receivables to annual sales percentage, ratio of current portion of accounts receivables to annual sales percentage, ratio of current inventory to annual sales percentage.

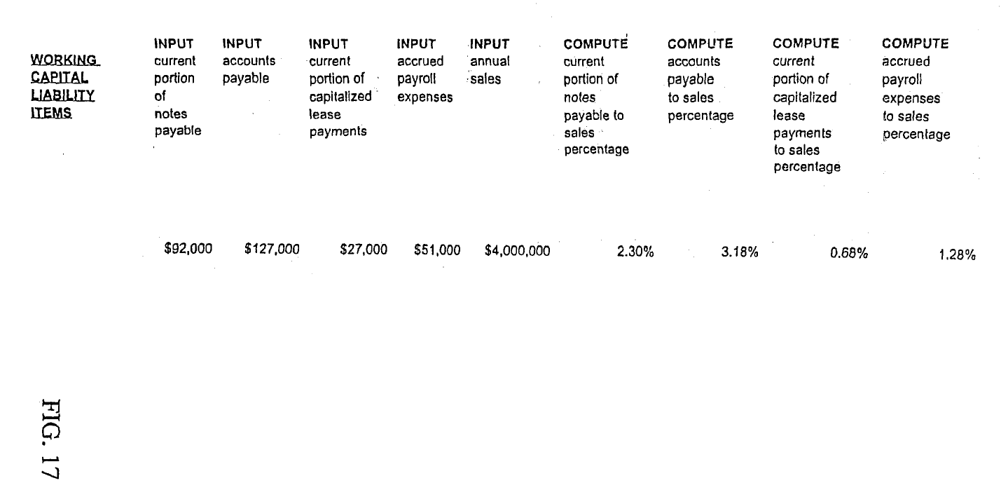

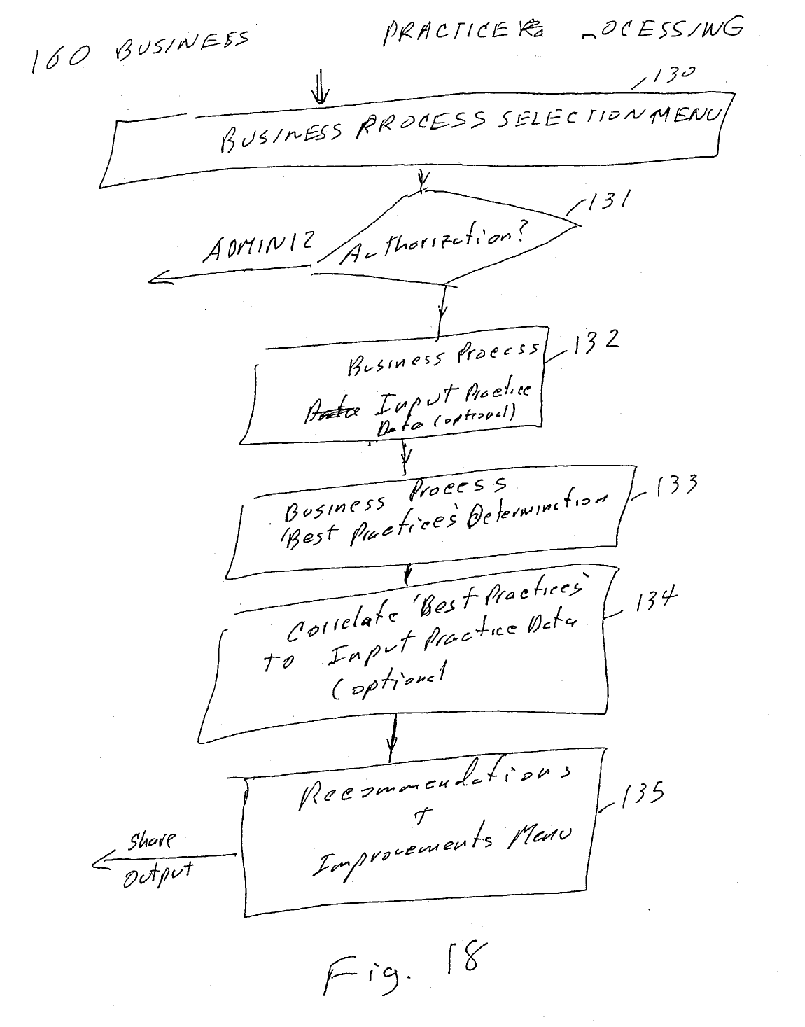

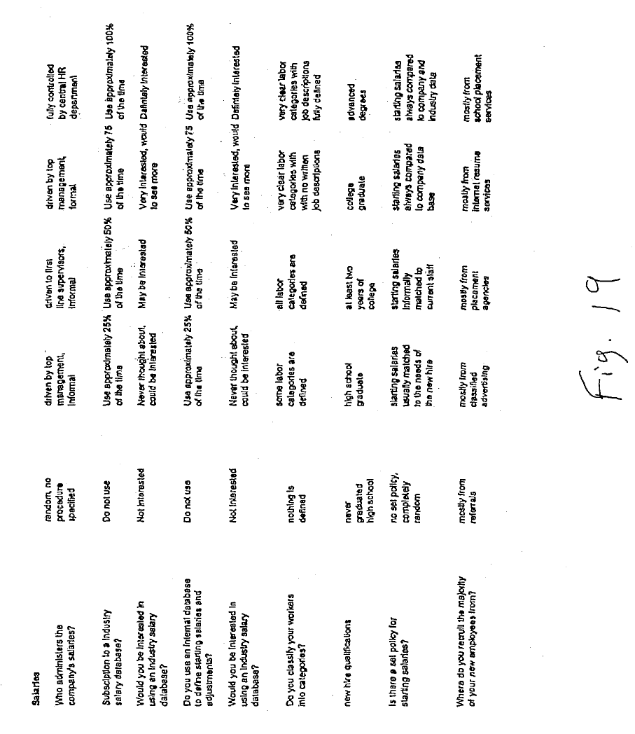

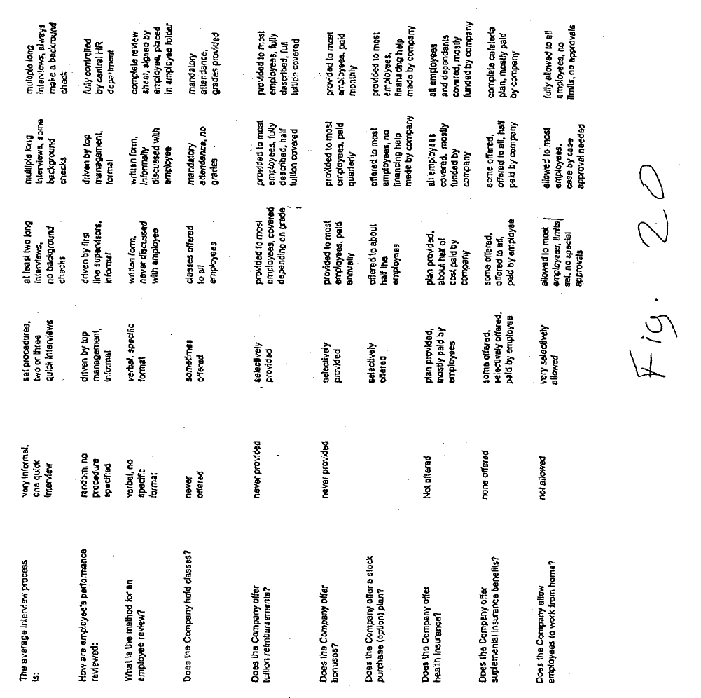

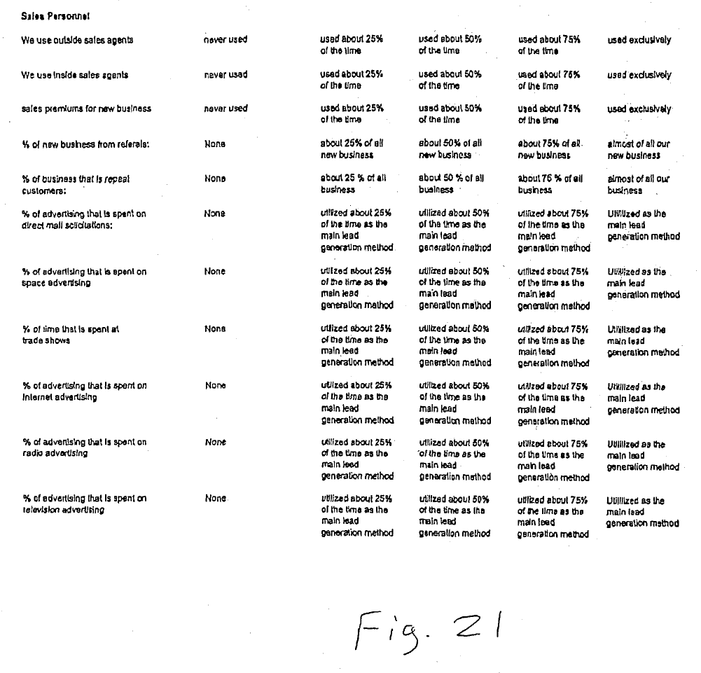

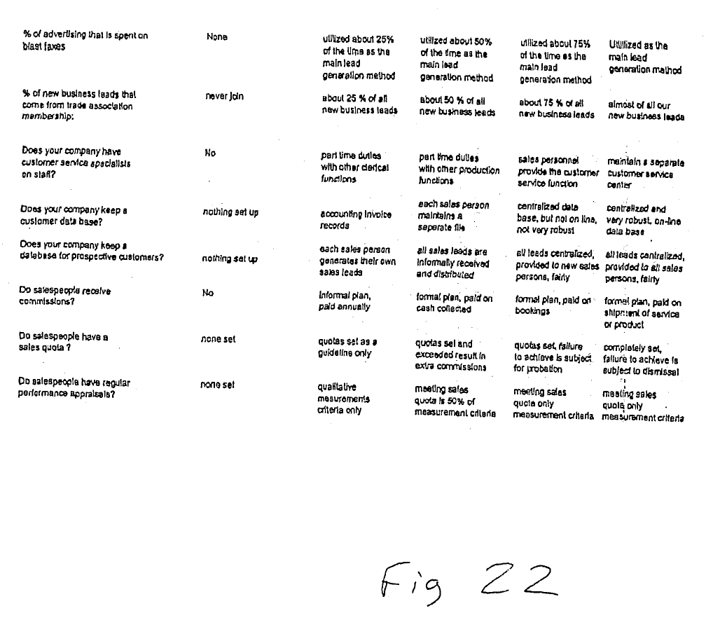

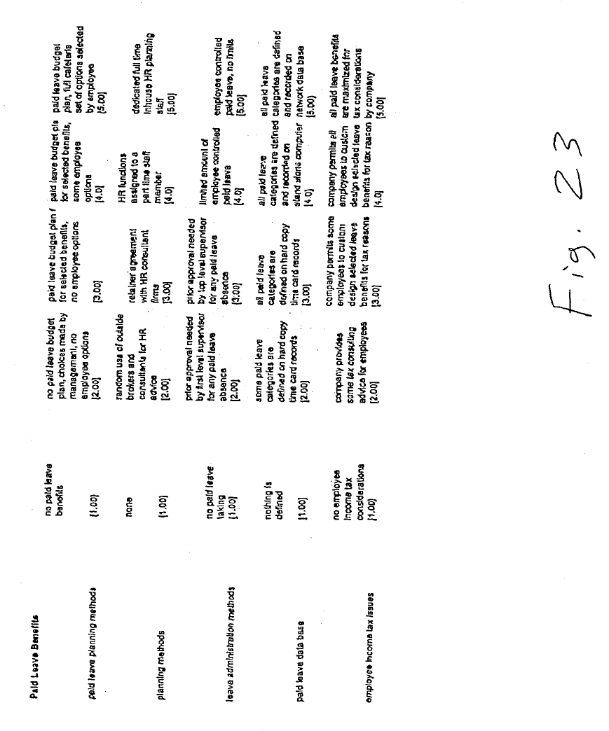

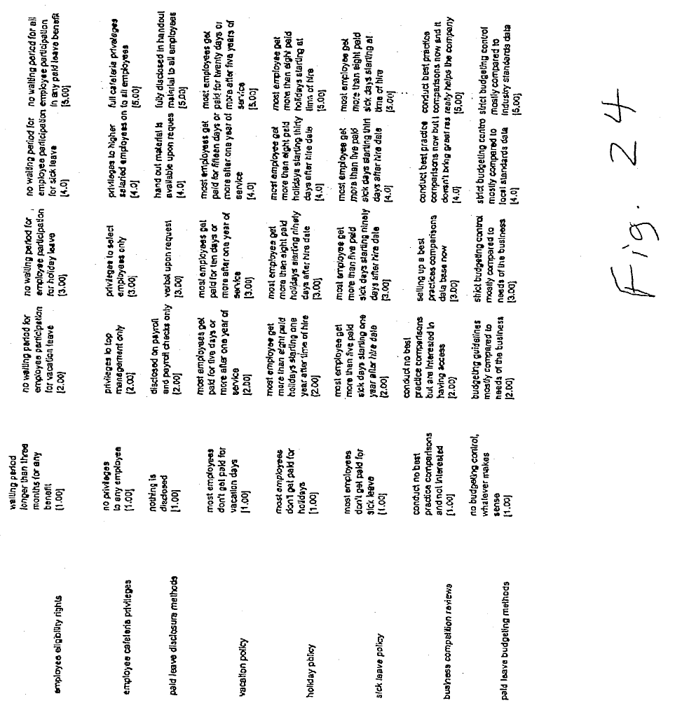

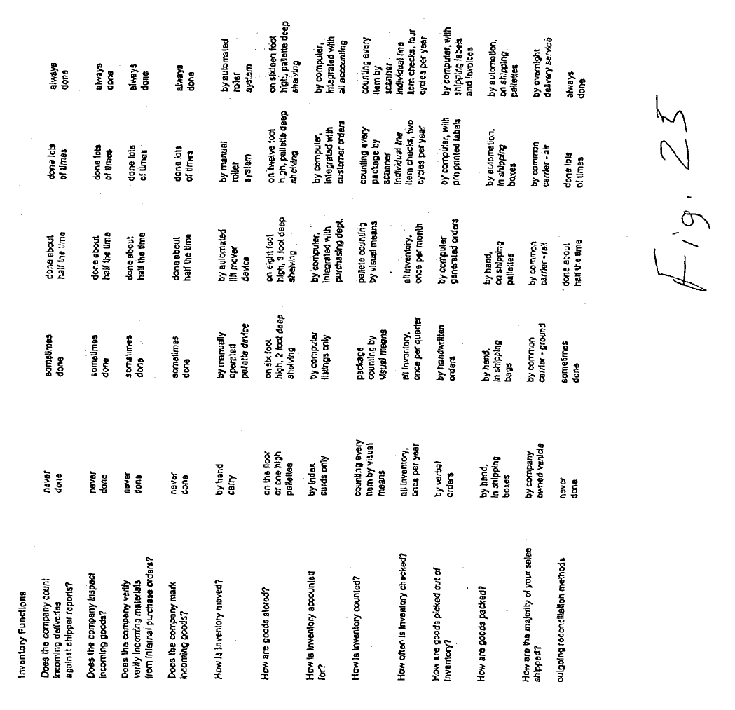

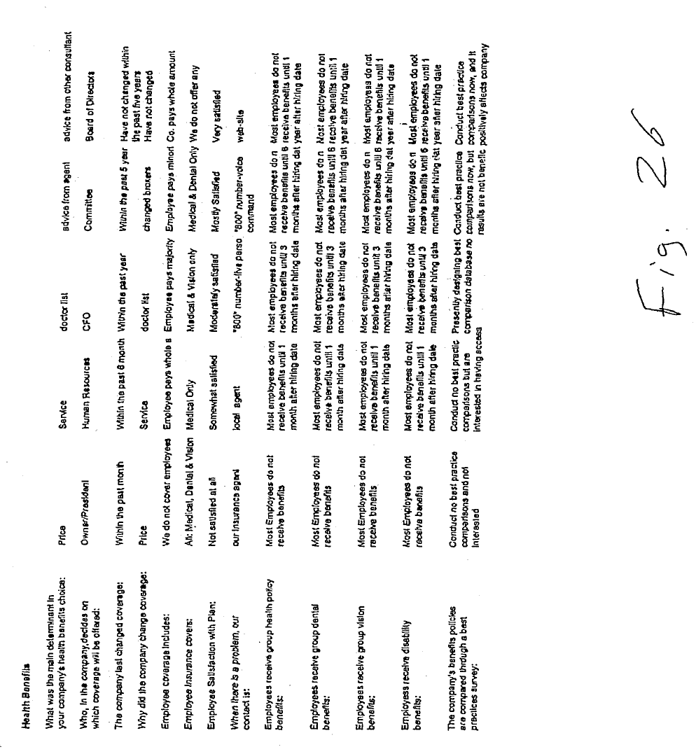

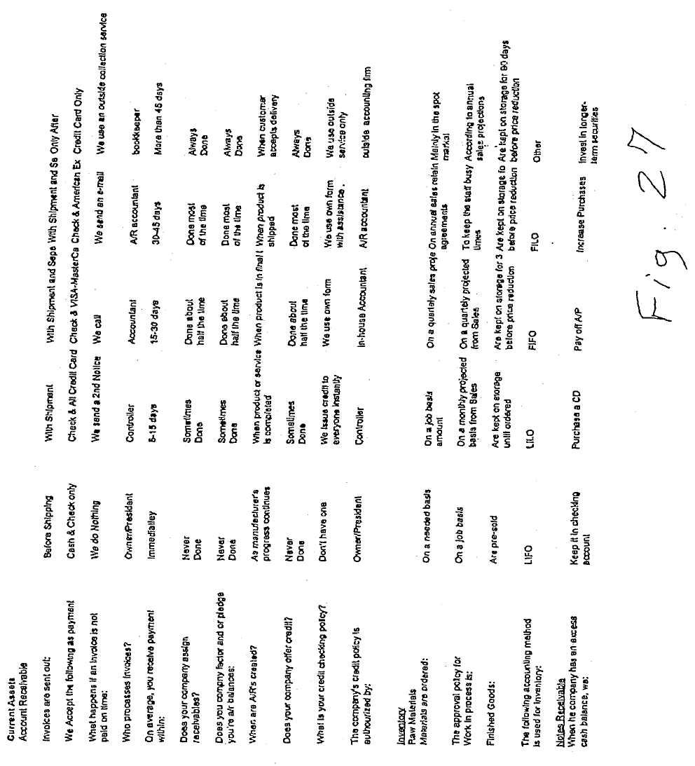

FIG. 17 shows bench marks for working capital liability items.

The bench mark input data for working capital liability items include: current portion of notes payable, accounts payable, current portion of capitalized lease payments, accrued payroll expenses, and annual sales.

The bench mark outputs for working capital liability items include: ratio of current portion of notes payable to sales percentage, ratio of accounts payable to sales percentage, ratio of current portion of capitalized lease payments to sales percentage, and ratio of accrued payroll expenses to sales percentage.

Additional Bench Marks

Industry affinity bench marks also include bench marks for industries like dental labs, optician shops, accounting firms, automobile parts manufacturers, etc. In these types of affinity groups the employees of the business will enter performance indicators regarding their area of expertise (accounting, inventory, regulatory compliance, engineering, etc.) and the bench mark system will provide the bench mark comparisons.

Measures of the activities of regulatory review agencies on regulatory approvals and rights for a company, such as regulatory approvals from the Food and Drug Administration (FDA), the United States Patent and Trademark Office (USPTO), and Securities and Exchange Commission (SEC), the Employment and Equal Opportunities Commission (EEOC), the National Transportation Safety Board (NTSB), Environmental protection Agency (EPA), Occupational Safety and health Administration (OSHA), and Federal Communication Commission (FCC), and corresponding governmental agencies around the world exist. These measures are referred to herein as regulatory bench marks. Examples of regulatory bench marks are the duration of pendency of regulatory applications for governmental approvals for new drugs, patents, trademarks, and certifications, and the duration from filing to first regulatory agency communication or the duration between regulatory communications during pendency of a regulatory application. The duration of pendency and duration between agency communications for a company's specific regulatory application, compared to the overall average duration of pendency for regulatory applications from members of the company's industry affinity group provides an industry affinity group bench mark, indicating how effective that company was in influencing regulatory action. Comparison of company wide averages for its regulatory applications to industry affinity group wide averages provides another industry affinity group bench mark related to regulatory review processes. The regulatory bench marks can be based upon geographic location of the applicant, costs to the applicant, consultant representative for the applicant, age of the representative, type of submission (e.g., electronic or paper).

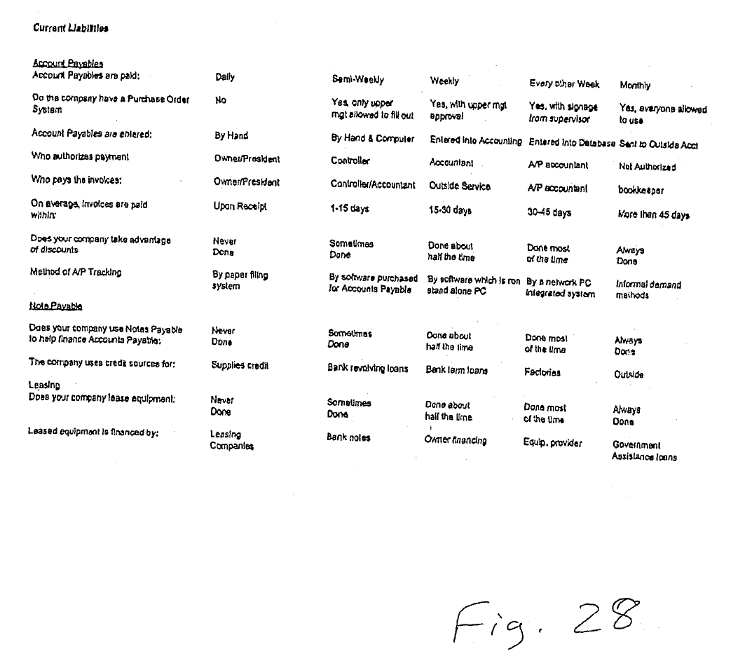

FIG. 18 is a flow chart showing use of the business process processing center 160 of FIG. 2. In step 130, the user is provided a menu containing business process choices. If the user selects a business process, the bench mark processing system 3 send the user's computer an authorization page 131, similar to step 31. In step 132, the user is prompted to input the business practices of the user's company that correspond to the user's selected business process. Step 132 is optional, in the sense the system can perform the functions identified in step 133 without that data, and the output of the function provided in step 133 is significant and useful. In step 133, the user enters the parameters that define affinity companies to the user's company. In step 133, the user also enters a bench mark and a range of values for that bench mark that must be met by a company for that company's practices relating to the bench mark to be defined as best practices. Once the user had input the parameters identifying defining what companies are in the affinity group and what bench mark values are required for companies in that group to be deemed best practices, the computer system 3 identifies companies meeting the user specified ranges and identifies the fraction of companies using each business practice associated with the user selected business process. The system 3 may simply display that data to the user (so the user can compare that data to its company's practices). However, if the user has input the user's company's practice data, the system can correlate the best practices results to the user's company's data, identify for the user the relative correlations of each practice, the average of the correlations for practices associated with the selected process, and identify low correlations. In addition, the system 3 can also automatically determine prescriptions for improvement of low correlations, for example suggesting products and services stored in the store 16 which have been predetermined to address low correlations of specified business practices with determined best practices.

FIGS. 19-28 each contain in the left hand column names of business practices, and possible values for those practices in the same row in the columns to the right of the business practice name column.

Obviously, numerous modifications and variations of the present invention are possible in light of the above teachings. It is therefore to be understood that within the scope of the appended claims, the invention may be practiced otherwise than as specifically described herein.

1. A computer implemented method comprising of the steps of: receiving bench mark data for a company for a bench mark at a bench marking computer;
determining a bench mark value for said company based at least in part upon said bench mark data;
ranking said bench mark value for said company relative to stored values for other companies for said bench mark; and
providing an indication based upon said ranking.

2. A method of claim 1 wherein said bench mark is a bench mark for one of paid leave benefits, paid health and disability benefits, inventory, licensing, salary, standard products, working capitol asset items, and working capitol liability items.

3. The method of claim 1 further comprising the step of transmitting said bench mark data from a client computer to said bench marking computer.

4. The method of claim 1 wherein said indication comprises of an indication of said ranking.

5. The method of claim 1 wherein said indication comprises an indication of an offer of a product or service.

6. The method of claim 1 wherein said indication depends upon said bench mark and said ranking.

7. The method of claim 1 wherein said indication comprises a prescription.

8. The method of claim 1 further comprising the step of storing said bench mark data for said company in association with an identification of said company in a database.

9. The method of claim 1 further comprising the steps of:
determining and identification of a user and rights associated with said identification;
and determining whether to determine said bench mark value, rank said bench mark value, or provide said indication based upon rights.

10. The method of claim 1 further comprising of the steps of:
determining an identification of a user and rights associated with said identification; and
determining whether to store said bench mark data for said company in association with an identification of said company in a database based at least in part upon said rights.

11. Method of claim 1 further comprising receiving and storing identification of users in association with rights of said users.

12. The system comprising:
means for receiving bench mark data for a company for a bench mark at a bench marking computer;
means for determining a bench mark value for said company based upon said bench mark data;
means for ranking said bench mark value for said company relative to stored values for other companies for said bench mark; and
means for providing an indication based upon said ranking.

13. The system of claim 12 wherein said bench mark is a bench mark for one of paid leave benefits, paid health and disability benefits, inventory, licensing, salary, standard products, working capitol asset items, working capitol liability items.

14. The system of claim 12 further comprising means for transmitting said bench mark data from a client computer to said bench marking computer.

15. The system of claim 1 wherein said indication comprises an indication of said ranking.

16. The system of claim 12 wherein said indication comprises an indication of an offer of a product or service.

17. The system of claim 12 wherein said indication depends upon said bench mark and said ranking.

18. The system of claim 12 wherein said indication comprises a prescription.

19. The system of claim 12 further comprising means for storing said benchmark data or said company in association with an identification of said company in a database.

20. The system of claim 12 further comprising:
means for determining an identification of a user and rights associated with a said identification; and
means for determining whether to determine aid bench mark value, rank said bench mark value, or provide said indication based upon said rights.

21. The system of claim 12 further comprising of the steps of:
means for determining an identification of a user and rights associated with said identification; and
means for determining whether to store said bench mark data for said company in association with an identification of said company in a database based at least in part upon said rights.

22. The system of claim 12 further comprising means for receiving and storing identifications of users in association with rights of said users.

23. A computer program product for programming a computer to perform the steps of:
receiving bench mark data for a company for a bench mark at a bench marking computer;
determining a bench mark value for said company based upon said bench mark data;
ranking said bench mark value for said company relative to stored values for other companies for said bench mark; and
providing an indication based upon said ranking.

24. At least one database comprising:
a record containing company data about a company;
a plurality of company user records; and
wherein each one of said plurality of company user record contains at least the following: data indicating an identification of a user, data indicating an identification of said company employing or contracting with said user, data indicating an address for said user, and data indicating said user's right to access said company data.

25. The database of claim 24 wherein said data indicating said user's rights to access data for said company comprises one of data indicating right to access all company data for said company and data indicating right to access at least one subset of all data for said company.

26. The database of claim 25 wherein said at least one subset comprises at least one of data for paid leave benefits, paid health and disability benefits, inventory, licensing, salary, standard products, working capital asset items, and working capitol liability items.

27. The database of claim 25 wherein said at least one subset comprises at least one of the following sets of bench mark input data: (1) number of equivalent full-time employees at the company, average number of paid vacation days per employee as a function of years of experience, average number of paid holidays as a function of years of experience, average number of other paid leave days as a function of years of experience, average annual gross salary as a function of years of experience, average amount of paid leave days as a function of years of experience and (2) the number of equivalent full time employees at the company, average annual gross salary per employee as a function of years of experience, monthly health benefit amount paid by company per employee as a function of years of experience, monthly dental benefit amount paid by company per employee as a function of years of experience, monthly vision benefit amount paid by company per employee as a function of years of experience, monthly disability amount paid by company per employee as a function of years of experience and (3) average dollar amount paid for health benefits per employee as a function of years of experience, average percent of salary paid for health benefits per employee as a function of years of experience, average dollar amount paid for dental benefits per employee as a function of years of experience, average percent of salary paid for dental benefits per employee as a function of years of experience, average dollar amount paid for vision benefits per employee as a function of years of experience, average percent of salary paid for vision benefits per employee as a function of years of experience, average dollar amount paid for disability benefits per employee as a function of years of experience, and average percent of salary paid for disability benefits per employee as a function of years of experience and (4) the average monthly dollar amount for each inventory type, the average monthly dollar sales for the total inventory, the average cost of goods percentage for total inventory and (5) state in which specified work is performed and (6) number of equivalent full time employees, average years of experience, average gross annual salary per employee and (7) number of full time sales persons, annual base salary of average sales person, average percent of sales paid out as commissions, average annual sales made by each sales person, and average size of every booking and (8) product definition, direct material costs for one production unit, direct number of labor hours to make one production unit, suggested unit sales price for low order volume, suggested unit sales price for high order volume, selected number of units to be measured and (9) cash or cash equivalents, current portion of notes receivable, accounts receivable that are less than 90 days old, current inventory including work in process, and annual sales and (10) current portion of notes payable, accounts payable, current portion of capitalized lease payments, accrued payroll expenses, and annual sales.

28. The database of claim 25 wherein said at least one subset comprises non regulatory bench mark input data.

29. The database of claim 25 wherein said at least one subset comprises bench mark input data including at least one of duration of pendency of an application in a regulatory review process, average duration between regulatory review communications in a regulatory review process, and average duration of pendency of a portfolio of applications in a regulatory review process.

30. The method of claim 24 wherein at least one of said company user records contains user log data.

31. A method of building at least one database comprising the steps of:
recording company data about a company;
recording a plurality of company user records; and
wherein each one of said plurality of company user record contains at least the following: data indicating an identification of a user, data indicating an identification of said company employing or contracting with said user, data indicating an address for said user, and data indicating said user's right to access said company data in said at least one database.

32. The method of claim 31 wherein at least one of said company user records contains user log data.

33. A method of building at least one database comprising the steps of:
recording company data about a company;
recording a plurality of company user records; and
wherein each one of said plurality of company user records contains at least the following: data indicating an identification of a user, data indicating an identification of said company employing or contracting with said user, data indicating an address for said user, and data indicating said user's right to input into said at least one database company data.

34. The method of claim 33 wherein at least one of said company user records contains user log data.

35. A method of generating a database comprising the steps of:
transmitting from a server computer system a solicitation for one of a group membership or a subscription to a client computer;
receiving at said server computer system (1) an identification of a company and (2) one of a group authorization code for said company or a subscription fee charge authorization for said company from said client computer;
transmitting from said server computer system to said client computer a request for data defining prospective user identifications for employees of said company or contractors to said company and, in association with each one of said prospective user identifications, data defining an email address, data defining a hierarchical position, and data defining what company data in a company data database is accessible based upon use of said user identification;
receiving at said server computer system data defining prospective user identifications and, in association with each one of said prospective user identifications, data defining an email address, data defining a hierarchical position, and data defining what company data in said company data database is accessible based upon use of said user identification; and
storing in a database data defining prospective user identifications and, in association with each one of said prospective user identifications, data defining an email address, data defining a hierarchical position, and data defining what company data in said company data database is accessible based upon use of said user identification.

36. The method of claim 35 wherein said step of storing comprises (1) storing in association with a first user identification data defining that all company data for a specified company is accessible based upon use of said first user identification and (2) storing in association with a second user identification data defining that not all company data for said specified company is accessible based upon use of said second user identification.

37. A computer implemented method comprising of the steps of:
receiving bench mark data for a company for a bench mark at a bench marking computer;
determining a bench mark value for said company based at least in part upon said bench mark data; and
providing an indication based at least in part upon said bench mark.

38. The method of claim 37 wherein said indication is an indication of at least one of a product and a service in a product and service category, and wherein said category depends upon said bench mark.

39. The method of claim 37 wherein said indication is based at least in part upon data in a user log.

40. A computer implemented system comprising:
means for receiving bench mark data for a company for a bench mark at a bench marking computer;
means for determining a bench mark value for said company based at least in part upon said bench mark data; and
means for providing an indication based at least in part upon said bench mark.

41. The method of claim 40 wherein said indication is an indication of at least one of a product and a service in a product and service category, and wherein said category depends upon said bench mark.

42. The method of claim 41 wherein said indication is based at least in part upon data in a user log.

43. A process for determining best practices, comprising the step of:
receiving business process definition data;
receiving organization affinity group definition data;
receiving bench mark range data for a bench mark;
determining a first subset of organizations identified in a database, which are all organizations identified in said database that meet said organization affinity group definition data;
determining a second subset of said first subset of companies which have a value for said bench mark in said bench mark range;
determining a fraction of companies in said second subset that employ a business practice associated with said business process; and
displaying said fraction.

44. The process according to claim 43 further comprising correlating said fraction to the a specified company's use of said practice.

45. The process according to claim 44 further comprising the step of automatically determining if said correlating provides a correlation below a predetermined value.

46. The process according to claim 44 further comprising the step of automatically displaying a prescription if said correlation is below said predetermined value.
